(19) United States
(12) Patent Application Publication
(10) Pub. No.: US 2020/0269303 A1
(43) Pub. Date: Aug. 27, 2020

(54) PUNCHING DEVICE AND SHEARING DEVICE

(71) Applicant: Panasonic Intellectual Property Management Co., Ltd., Osaka (JP)

(72) Inventors: MASAYUKI TAKAHASHI, Osaka (JP); KEITARO FUJII, Osaka (JP); MASAHIRO KUBO, Osaka (JP)

(21) Appl. No.: 16/792,641

(22) Filed: Feb. 17, 2020

(30) Foreign Application Priority Data
Feb. 27, 2019 (JP) 2019-033766

(51) Int. Cl. B21D 24/10; G01L 1/16; G01L 5/167; B21D 28/02; B21D 28/34; G01L 1/26

(52) U.S. Cl. CPC B21D 24/10; G01L 1/16; G01L 1/26; B21D 28/02; B21D 28/34; G01L 5/167

(57) ABSTRACT

A punching device and the like contributing to high-quality punching processing that punches a flat workpiece by a punch includes a measuring instrument for calculating translational forces generated in respective directions of orthogonal two axes in a plane orthogonal to an axis extending along a punching direction by the punch in forces generated at the time of punching the workpiece.

### TECHNICAL FIELD

The technical field relates to a punching device punching workpieces such as metal, plastic and composite materials and a shearing device.

### BACKGROUND

As a related-art punching device, there exists a device capable of measuring a processing resistance generated at the time of punching the workpiece (for example, refer to JP-A-62-40938 (Patent Literature 1). FIGS. 9A and 9B are views showing a related-art punching device described in Patent Literature 1.

In the punching device shown in FIG. 9A, a bolster plate 102 and a press slide 103 are supported by a frame 101. A strain gauge 105 is adhered to the frame 101. A die for punching is normally installed above the bolster plate 102. When punching processing is performed by vertically moving the press slide 103 for punching, a strain occurs in the frame 101 due to processing resistance. The punching device is configured to detect the strain occurring due to punching processing by the strain gauge 105, to amplify the strain as an electrical quantity by a strain-electricity transducer 111 and to record the electrical quantity by a recording device 112.

In FIG. 9B, values of strains occurring by punching processing are shown as a strain quantity A in the drawing. The strain quantity A in the example is obtained by detecting and quantifying strains corresponding to processing resistance in an operation direction, namely, a vertical direction of the press slice 103, which is a punching direction. More specifically, the processing resistance different according to conditions such as a material or a thickness of the workpiece, processing conditions such as a punching speed and an abrasion state of a punching tool in the die is represented quantitatively as the strain quantity of the frame of the punching device. The strain quantity A is generated as a result of elastic deformation of the frame 101, which can be regarded that the strain quantity A is in proportion to the processing resistance in the punching direction. Therefore, there is an advantage that the processing resistance is increased when a punch or a die as the punching tool is worn out, which makes detection of a tool lifetime easier.

### SUMMARY

However, only the processing resistance in the punching direction can be detected in the punching device described in Patent Literature 1. Accordingly, in a case where, for example, the processing resistance is increased and an abnormal value is indicated, it is difficult to discriminate whether the processing resistance is increased due to the abrasion of the punch or the die as the punching tool or whether the processing resistance is increased due to an error generated in assembly such as concentricity of the punching die, namely, axis misalignment between the punch and the die as the punching tools. Even when the lifetime of the punch or the die is changed as compared with a related art tool at the time of replacing the tool as the processing resistance becomes a prescribed value, it is difficult to identify what is a cause of variation in the tool lifetime. Accordingly, there is a problem that it is difficult to achieve high-quality punching processing only by detecting the processing resistance in the punching direction as in related art.

The present disclosure has been made for solving the above related-art problems, and an object thereof is to provide a punching device and the like contributing to high-quality punching processing.

In order to achieve the above object, a punching device according to the present disclosure is a punching device punching a flat workpiece by a punch, which includes a measuring instrument for calculating translational forces generated in respective directions of orthogonal two axes in a plane orthogonal to an axis extending along a punching direction by the punch in forces generated at the time of punching the workpiece.

In order to achieve the above object, a shearing device according to the present disclosure is a shearing device shearing a flat workpiece by a shearing tool, which includes a measuring instrument for calculating translational forces generated in respective directions of orthogonal two axes in a plane orthogonal to an axis extending along a direction in which a shearing force works in forces generated at the time of shearing the workpiece.

When adopting the punching device according to the present disclosure, high-quality punching processing can be realized. When adopting the shearing device, high-quality searing processing can be realized.

### BRIEF DESCRIPTION OF THE DRAWINGS

FIGS. 1A to 1C are views showing a basic structure of a punching device according to Embodiment 1;

FIGS. 2A and 2B are views showing loads detected in the punching device and correction of misalignment between a punch and a die according to Embodiment 1;

FIGS. 3A and 3B are views showing a basic structure of the punching device according to Embodiment 2;

FIG. 4 is a view showing an example of arrangement of measuring instruments in the punching device according to Embodiment 2;

FIG. 5 is a view showing a drive unit of the punching device according to Embodiment 3;

FIG. 6 is a flowchart showing a method of punching processing using the punching device according to Embodiment 3;

FIG. 7 is a view showing the entire structure of the punching device according to Embodiment 3;

FIGS. 8A and 8B are views showing loads detected in the punching device and correction of misalignment between the punch and the die according to Embodiment 3; and

FIGS. 9A and 9B are views showing a related-art punching device.

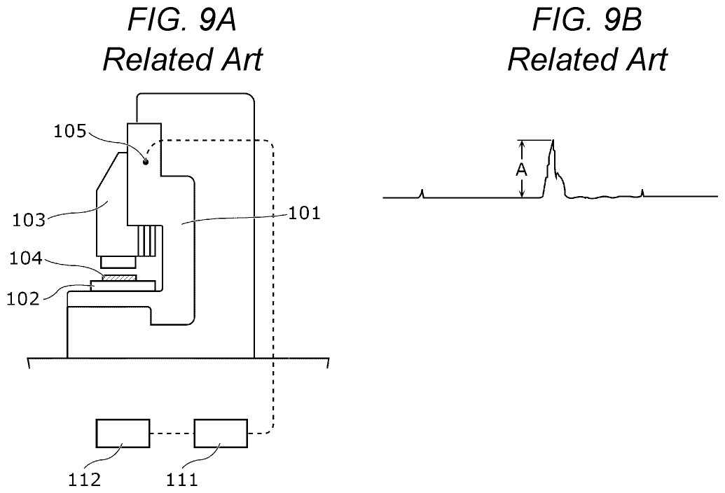

### DESCRIPTION OF EMBODIMENTS

A punching device according to the present disclosure is a punching device punching a flat workpiece by a punch, including a measuring instrument for calculating translational forces generating in respective directions of orthogonal two axes in a plane orthogonal to an axis extending along a punching direction by the punch in forces generated at the time of punching the workpiece.

When the punching device has the measuring instrument for calculating the translational forces generated in the plane orthogonal to the axis extending along the punching direction as described above, for example, a punching die of the punching device can be adjusted based on the translational forces calculated by the measuring instrument. Accordingly, the punching device contributing to high-quality punching processing can be provided.

The above measuring instrument may further be used for calculating a moment about the axis extending along the punching direction.

When the punching device has the measuring instrument for calculating the moment about the axis as described above, the punching die of the punching device can be adjusted based on the moment about the axis. Accordingly, the punching device contributing to high-quality punching processing can be provided.

It is also preferable that at least three measuring instruments are provided, and that the respective measuring instruments are arranged on the same plane orthogonal to the axis extending along the punching direction.

When the measuring instruments are arranged on the same plane as described above, the translational forces can be calculated at high accuracy. Accordingly, the punching device contributing to high-quality punching processing can be provided.

It is further preferable that one or more measuring instruments are respectively arranged at three areas in four areas divided by the orthogonal two axes on the plane when the plane is seen from the punching direction.

When the measuring instruments are respectively arranged at three areas in the plane, the measuring instruments are arranged apart from one another; therefore, the translational forces can be calculated at high accuracy. Accordingly, the punching device contributing to high-quality punching processing can be provided.

The punching device may also have a die having a shape corresponding to the punch and a computing device calculating movement distances of the die or the punch to respective directions of the orthogonal two axes, and the computing device may calculate the movement distances based on the translational forces.

When the computing device calculates the movement distances based on the translational forces as described above, axis misalignment of the punching die can be automatically adjusted. Accordingly, the punching device contributing to labor saving can be provided.

The computing device may further calculate a rotation angle about the axis of the die or the punch based on the moment about the axis.

When the computing device calculates the rotation angle based on the moment about the axis as described above, rotational deviation of the punching die can be automatically adjusted. Accordingly, the punching device contributing to labor saving can be provided.

The measuring instruments may be first processing resistance measuring instruments for calculating the translational forces generating at the time of punching the workpiece, and a second processing resistance measuring instrument for calculating the moment about the axis extending along the punching direction may further be provided.

When the punching device includes the first processing resistance measuring instruments and the second processing resistance measuring instrument as described above, for example, the punching die of the punching device can be adjusted based on the translational forces and the moment about the axis. Accordingly, the punching device contributing to high-quality punching processing can be provided.

The punching device may include at least three first processing resistance measuring instruments, and respective first processing resistance measuring instruments may be arranged on the same plane orthogonal to the axis extending along the punching direction.

When the first processing resistance measuring instruments are arranged on the same plane as described above, the translational forces can be calculated with high accuracy. Accordingly, the punching device contributing to high-quality punching processing can be provided.

One or more first processing resistance measuring instruments may be respectively arranged at three areas in four areas divided by the orthogonal two axes on the plane when the plane is seen from the punching direction.

When the first processing resistance measuring instruments are respectively arranged at three areas in the plane as described above, the first processing resistance measuring instruments are arranged apart from one another; therefore, the translational forces can be calculated with high accuracy. Accordingly, the punching device contributing to high-quality punching processing can be provided.

The punching device may further include a die having a shape corresponding to the punch and a computing device calculating movement distances of the die or the punch to respective directions of the orthogonal two axes, and the computing device may calculate the movement distances based on the translational forces calculated by the first processing resistance measuring instruments.

When the movement distances are calculated by the computing device based on the translational forces as described above, the axis misalignment of the punching die can be automatically adjusted. Accordingly, the punching device contributing to labor saving can be provided.

The computing device may further calculate a rotation angle about the axis of the die or the punch based on the moment about the axis calculated by the second processing resistance measuring instrument.

When the computing device calculates the rotation angle based on the moment about the axis as described above, rotational deviation of the punching die can be automatically adjusted. Accordingly, the punching device contributing to labor saving can be provided.

A shearing device according to the present application is a shearing device shearing a flat workpiece by a shearing tool, including a measuring instrument for calculating translational forces generated in respective directions of the orthogonal two axes in a plane orthogonal to an axis extending along a direction in which a shearing force works in forces generated at the time of shearing the workpiece.

When the shearing device has the measuring instrument for calculating the translational forces generated in the plane orthogonal to the axis extending along the direction in which the shearing force works as described above, for example, a die of the shearing device can be adjusted based on the translational forces. Accordingly, the shearing device contributing to high-quality shearing processing can be provided.

Hereinafter, embodiments will be explained with reference to the drawings. All embodiments explained below show preferable specific examples of the present application. Therefore, numeral values, shapes, materials, components, arrangement positions and connection states of components and the like are examples, which do not intend to limit the present disclosure. Accordingly, components not described in independent claims showing most generic concepts of the present disclosure in components according to the following embodiments will be explained as arbitrary components.

Note that respective drawings are schematic views, and are not always strictly shown. Also in respective drawings, the same signs are added to the substantially same components, and repeated explanation is omitted or simplified.

### Embodiment 1

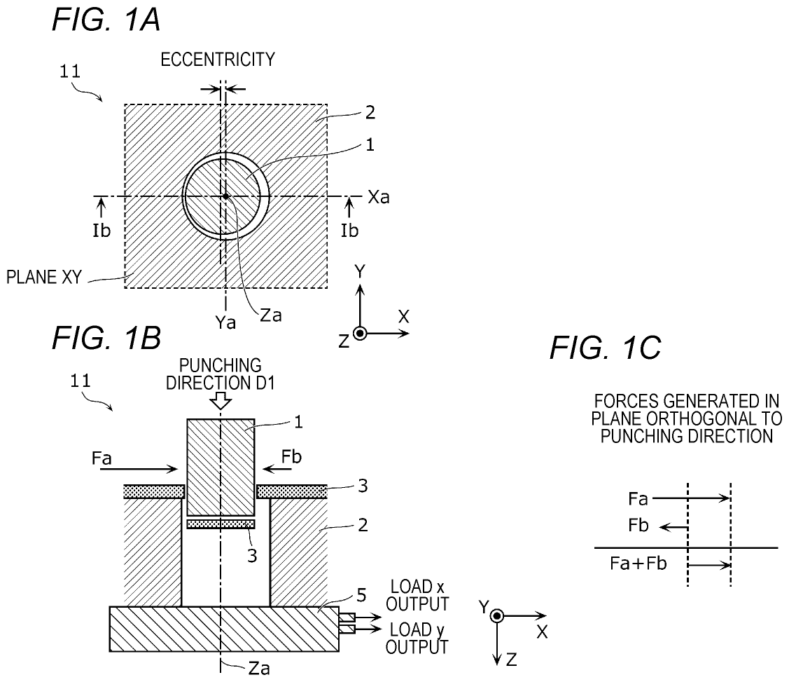

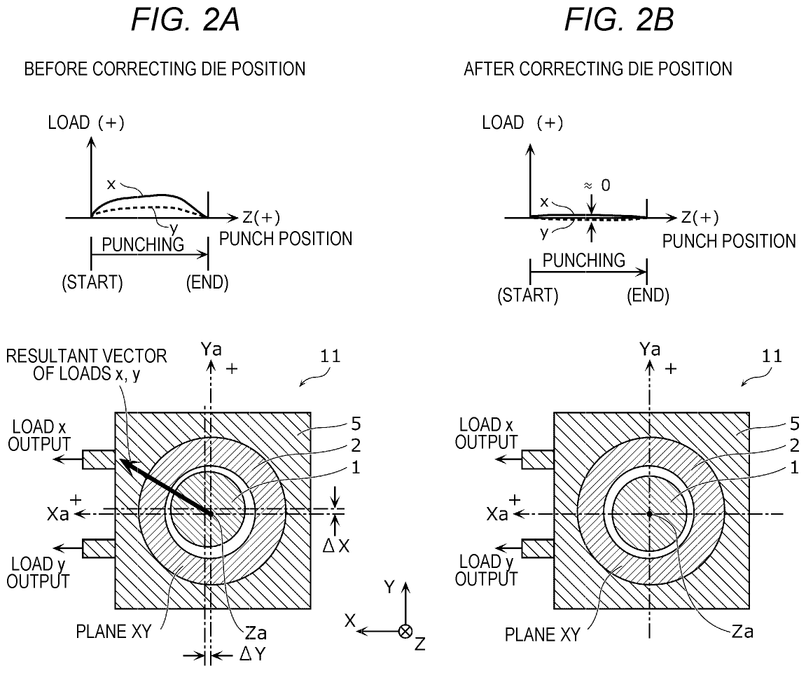

Hereinafter, a punching device according to Embodiment 1 will be explained with reference to FIGS. 1A to 1C, and FIGS. 2A and 2B.

FIGS. 1A to 1C are views showing a basic structure of a punching device 11 according to Embodiment 1. The punching device 11 is a device for punching a flat workpiece 3. As the workpiece 3, for example, a metal plate, a resin substrate, a resin sheet, a composite material substrate and so on can be cited. The punching device 11 has a stand, a movable plate, an upper plate, a servo motor as a driving source and so on; however, these are not shown and a punching die is mainly shown in FIGS. 1A to 1C.

The punching die of the punching device 11 is formed by a punch 1 as a punching tool with a circular cross section and a die 2 having a shape corresponding to the punch 1. A workpiece 3 is arranged between the punch 1 and the die 2 before the punching processing is performed.

When the workpiece 3 is punched, a force generated in a punching direction D1 and translational forces generated in respective directions of orthogonal two axes (Xa-axis, Ya-axis) in a plane XY orthogonal to a Za-axis extending along the punching direction D1 are generated. In the punching device 11 according to the embodiment, a measuring instrument 5 for calculating the translational forces is arranged under the die 2. The measuring instrument is a load cell such as a piezoelectric load sensor.

In FIG. 1A, the workpiece 3 is not drawn for showing eccentricity as the axis misalignment between the punch 1 and the die 2 in a manner easily understood. In a case where the punching processing is performed by using the punching die, such eccentricity is not desirable; however, eccentricity actually occurs to some degree. However, a value of eccentricity is a value of approximately several micrometers to ten-odd micrometers, and it is difficult to visually determine an eccentric amount. FIG. 1B is a view showing a cross section Ib-Ib of FIG. 1A. FIG. 1B shows a state just after the punch 1 moves down in a vertical direction and the workpiece 3 is punched.

For example, when the punch 1 is eccentric with respect to the die 2, a clearance between the punch 1 and the die 2 has the narrowest part and the widest part at positions opposite to each other by 180 degrees in a plane XY. In FIG. 1C, forces generated in the plane XY due to the difference in the clearance are shown as Fa and Fb. Lengths of arrows Fa and Fb indicate magnitudes of forces. The two forces Fa and Fb in the punching die shown in FIG. 1A and 1B are not balanced with each other as the punch 1 is eccentric with respect to the die 2. Directions of the two forces Fa and Fb differ from each other by 180 degrees, a force finally detected by the measuring instrument 5 will be Fa+Fb. On the other hand, when the punch 1 is not eccentric with respect to the die 2 in the punching die, a clearance is uniform at opposite positions by 180 degrees in the plane XY, and the forces Fa and Fb generated in the plane XY cancel each other; therefore, the force is not detected by the measuring instrument 5.

FIGS. 2A and 2B are views showing loads x and y detected in the punching device 11 and correction of misalignment between the punch 1 and the die 2 according to Embodiment 1. An example of the punching device 11 on which the same punching die as in FIGS. 1A to 1C is mounted is shown in FIGS. 2A and 2B. The same signs are used for the same components as those of FIGS. 1A to 1C, and explanation thereof is omitted.

FIG. 2A shows a state in which the punching processing is performed while the punch 1 and the die 2 are assembled in an eccentric manner. The measuring instrument 5 is installed under the die 2. When outputs of the measuring instrument 5 are observed in this state, a waveform shown on an upper part of FIG. 2A can be obtained. A vertical axis in FIG. 2A represents the load and a horizontal axis represents the position of the punch 1 when an initial position of the punch 1 is set to zero. The horizontal axis may represent time when a timing of starting the punching processing is set to zero.

When the punch 1 is eccentric with respect to the die 2, the load x and the load y are generated in the plane XY as described above. The load x and the load y generated in the XY plane here are called a translational force x in an Xa-axis direction and a translational force y in a Ya-axis direction. The force measured by the measuring instrument 5 is a force caused by the eccentricity between the punch 1 and the die 2; therefore, the eccentric amount and an eccentric direction of the punch 1 and the die 2 shown in a lower part of FIG. 2A can be easily detected from a resultant vector of the translational force x in the Xa-axis direction and the translational force y in the Ya-axis direction.

The respective axes of the punch 1 and the die 2 can be aligned so as to correspond to each other based on the eccentric amount and the eccentric direction. A specific alignment work is to adjust relative positions of the punch 1 and the die 2 in the punching die. For example, it is possible to shave the punching die or to hammer the die for adjusting the positions. Then, when the positions of the punch 1 and the die 2 are corrected as shown in a lower part of FIG. 2B after the punching die is assembled again and punching processing is performed, the load x and the load y in the plane XY, namely, the translational force x and the translational force y are reduced as shown in an upper part of FIG. 2B. The fact that the translational force x and the translational force y are small means that the axes of the punch 1 and the die 2 of the punching die correspond to each other.

To what degree the load x and the load y in the plane XY should be reduced is not particularly defined and differs according to the size of the die and required accuracy. The smaller the load x and the load y in the plane XY become, the smaller eccentric amounts ΔX and ΔY shown in the lower part of FIG. 2A become. When the load x and the load y in the plane XY, namely, the eccentric amounts ΔX and ΔY are reduced, quality of a sheared surface of the workpiece 3 can be uniformly stabilized.

As shown in FIGS. 2A and 2B, in the punching die for punching the workpiece 3 in a circular shape, variations of the load x and the load y in the plane XY are monitored not only during adjustment of the die but also in the middle of the continuous punching work, thereby checking the stability of quality. In a case where the stability of quality obtained as a result of monitoring is not good, the quality of punching processing can be improved by performing alignment work.

There were problems that burrs are partially generated on the sheared surface of the workpiece and that a lifetime of the die is not stable due to the eccentricity between the punch and the die in the related-art punching device. In response to the problems, the load x and the load y applied to the workpiece 3 become uniform and the partial generation of burrs is reduced at the time of punching processing by using the punching device 11 according to the embodiment. Moreover, there is an excellent advantage that the die lifetime becomes stable.

Although the example in which the two-axis load sensor detecting loads in the Xa-axis direction and the Ya-axis direction is used as the measuring instrument 5 is shown in the embodiment, a three-axis load sensor capable of detecting also a load in a Za-axis direction in addition to the loads in the Xa-axis direction and the Ya-axis direction may be used. Moreover, the piezoelectric load sensor is used as the measuring instrument 5; however, a strain gauge load sensor may be used.

### Embodiment 2

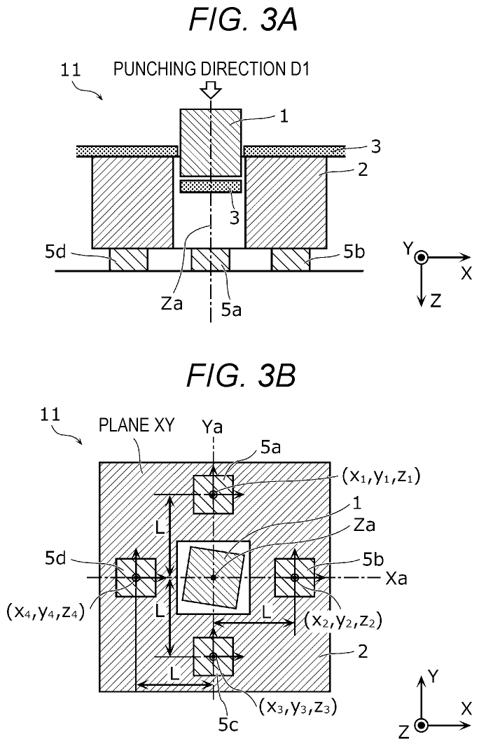

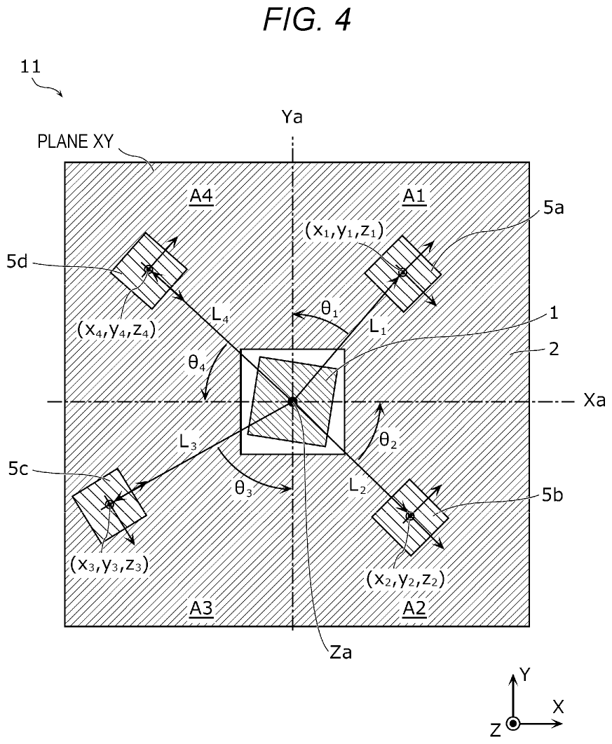

Next, the punching device 11 according to Embodiment 2 will be explained with reference to FIGS. 3A, 3B, and FIG. 4.

Although the example in which the forces generated in the plane XY are calculated by one measuring instrument 5 is shown in Embodiment 1, an example in which forces generated in the plane XY and a moment are calculated by a plurality of measuring instruments 5a to 5d will be explained in Embodiment 2.

FIGS. 3A and 3B are views showing a basic structure of the punching device 11 according to Embodiment 2. In FIGS. 3A and 3B, the same signs are used for the same components as those in FIGS. 1A to 1C, FIGS. 2A and 2B, and explanation thereof is omitted.

The punching die shown in FIGS. 3A and 3B largely differs from the punching die according to Embodiment 1 in a point that the punch 1 and a hole in the die 2 have a rectangular shape. The punch 1 according to Embodiment 1 has the circular shape and the clearance between the punch 1 and the die 2 does not change even when rotation occurs about the Za-axis; however, in the case where the punch 1 has the rectangular shape as in Embodiment 2, rotation occurs about the Za-axis and the clearance between the punch 1 and the die 2 changes. In Embodiment 2, rotational deviation about the axis can be also detected with the detection of axis misalignment between the punch 1 and the die 2 on the plane XY by arranging the plural measuring instruments 5a to 5d as described below. In Embodiment 2, the three-axis load sensor capable of detecting also the force in the Za-axis direction is used as the measuring instruments 5a to 5d.

FIG. 3A shows a cross-sectional view of a state just after the workpiece 3 is punched by the punch 1. The axis misalignment of the punch 1 occurs with respect to the die 2 and relative rotational deviation about the axis also occurs. However, it is difficult to visually check the axis misalignment and the rotational deviation as a clearance between the punch 1 and the die 2 is on the order of ten-odd micrometers.

FIG. 3B is a bottom view showing arrangement of four measuring instruments 5a, 5b, 5c and 5d. In FIG. 3B, the workpiece is not shown.

In the punching device 11 according to Embodiment 2, all measuring instruments 5a, 5b, 5c and 5d are arranged on the same plane XY. As shown in the drawing, the measuring instruments 5a and 5c are arranged on the Ya-axis at positions apart from the center of the die 2 by equal distances L. The measuring instruments 5b and 5d are arranged on the Xa-axis at positions apart from the center of the die 2 by equal distances L. Here, when the workpiece 3 is punched by using the punching device 11, loads x1 to x4, loads y1 to y4, and loads z1 to z4 in the three-axis directions are detected by the four measuring instruments 5a to 5d. Accordingly, the translational force x in the Xa-axis direction, the translational force y in the Ya-axis direction and the force z generated in the Za-axis direction are represented by the following Formula (1). Note that subscripts 1, 2, 3, and 4 of respective loads x, y, and z are numerals corresponding to respective measuring instruments 5a, 5b, 5c, and 5d.

x=x₁+x₂+x₃+x₄

y=y₁+y₂+y₃+y₄

z=Z₁+Z₂+Z₃+Z₄ (1)

When the above-described clearance is uniform, values of the translational force x and the translational force y in Formula (1) will be zero. A value of z in Formula (1) indicates a processing resistance force in the Za-axis direction generated at the time of punching processing.

A moment My about the Za-axis caused by relative rotation of the punch 1 and the die 2 is represented by the following Formula (2).

M_{y}=(x₁−x₃−y₂+y₄)L (2)

It is found that from Formula (2) that detection sensitivity is increased when positions of the four measuring instruments 5a to 5d (distances L from the Za-axis) are longer. In the case where relative rotational deviation about the axis between the punch 1 and the die 2 does not occur, x1=x3, y2=y4 and it is found that the moment Mγ will be zero.

Next, positions of the measuring instruments 5a to 5d are further examined with reference to FIG. 4.

FIG. 4 is a view showing an example of arrangement of the measuring instruments 5a to 5d in the punching device 11 according to Embodiment 2. The measuring instruments 5a to 5d in the drawing are arranged so that distances from the Xa-axis, the Ya-axis and the Za-axis differ from one another. As shown in FIG. 4, in a case where the respective measuring instruments 5a, 5b, 5c, and 5d are arranged so as to correspond to a first area A1, a second area A2, a third area A3, and a fourth area A4 respectively, values of the translational force x, the translational force y, and the processing resistance force z can be calculated as shown in Formula (3). The first area A1, the second area A2, the third area A3, and the fourth area A4 are four areas formed by being divided by orthogonal two axes (Xa-axis, Ya-axis) on the plane XY when the plane XY is seen from the punching direction D1. Note that subscripts 1, 2, 3, and 4 of respective rotation angles θ are numerals corresponding to the respective measuring instruments 5a, 5b, 5c, and 5d.

$$( \begin{matrix}x \\ y \\ z\end{matrix} ) = ( \begin{matrix}cos {θ}_{1} & - sin {θ}_{1} & 0 \\ sin {θ}_{1} & cos {θ}_{1} & 0 \\ 0 & 0 & 1\end{matrix} ) ( \begin{matrix}{x}_{1} \\ {y}_{1} \\ {z}_{1}\end{matrix} ) + ( \begin{matrix}cos {θ}_{2} & - sin {θ}_{2} & 0 \\ sin {θ}_{2} & cos {θ}_{2} & 0 \\ 0 & 0 & 1\end{matrix} ) ( \begin{matrix}{x}_{2} \\ {y}_{2} \\ {z}_{2}\end{matrix} ) + ( \begin{matrix}cos {θ}_{3} & - sin {θ}_{3} & 0 \\ sin {θ}_{3} & cos {θ}_{3} & 0 \\ 0 & 0 & 1\end{matrix} ) ( \begin{matrix}{x}_{3} \\ {y}_{3} \\ {z}_{3}\end{matrix} ) + ( \begin{matrix}cos {θ}_{4} & - sin {θ}_{4} & 0 \\ sin {θ}_{4} & cos {θ}_{4} & 0 \\ 0 & 0 & 1\end{matrix} ) ( \begin{matrix}{x}_{4} \\ {y}_{4} \\ {z}_{4}\end{matrix} ) \qquad ( 3 )$$

The moment My about the Za-axis is represented by Formula (4). Subscripts 1, 2, 3, and 4 of respective distances L are numerals corresponding to the respective measuring instruments 5a, 5b, 5c, and 5d.

The arrangement of the measuring instruments 5a to 5d is an example. When the measuring instruments 5a to 5d are respectively arranged so as to correspond to the first areas A1 to the fourth area A4 at the time of actually designing the die, the translational force x, the translational force y, the processing resistance force z and the moment Mγ can be calculated in the same manner.

Embodiment 2 is superior to Embodiment 1 in the following points. For example, the punching shape of the die can adopt shapes other than the circular shape, which can expand an application range of punching processing.

In a case where assembly accuracy of the punch 1 and the die 2 in the punching die is not good, or in a case where relative positional misalignment occurs in the punch 1 or the die 2 during the punching processing, the translational forces in the Xa-axis direction and the Ya-axis direction or the moment My about the Za-axis occur at the time of the punching processing. In such case, it is necessary to align axes at the time of assembling the punch 1 and the die 2 inside the die; however, unnecessary quality trouble and reduction in the die lifetime can be suppressed also in Embodiment 2 by aligning axes in the same manner as in Embodiment 1.

Although the two-axis sensor capable of detecting translational forces in the Xa-axis direction and the Ya-axis direction may be used for the measuring instruments 5a to 5d, the three-axis sensor is used for the measuring instruments 5a to 5d as it is more convenient that the processing resistance in the punching direction D1 is detected together for checking the punching accuracy in Embodiment 2.

Moreover, four measuring instruments are used in Embodiment 2; however, the same effect can be obtained by using three or more measuring instruments. In the case where three measuring instruments are used, the measuring instruments may be arranged to three areas in the areas A1 to A4 respectively. The smaller number of measuring instruments is, the lower the cost will be; therefore, it is desirable to use three or four measuring instruments.

Moreover, a four-axis sensor of X1-Y1-Z1-Mγ or the three-axis sensor not including the Za-axis may be arranged just below in the punching direction D1 in the same manner as in Embodiment 1. The use of such measuring instruments contributes to high quality punching processing even when the punch 1 and the die 2 have any shape.

### Embodiment 3

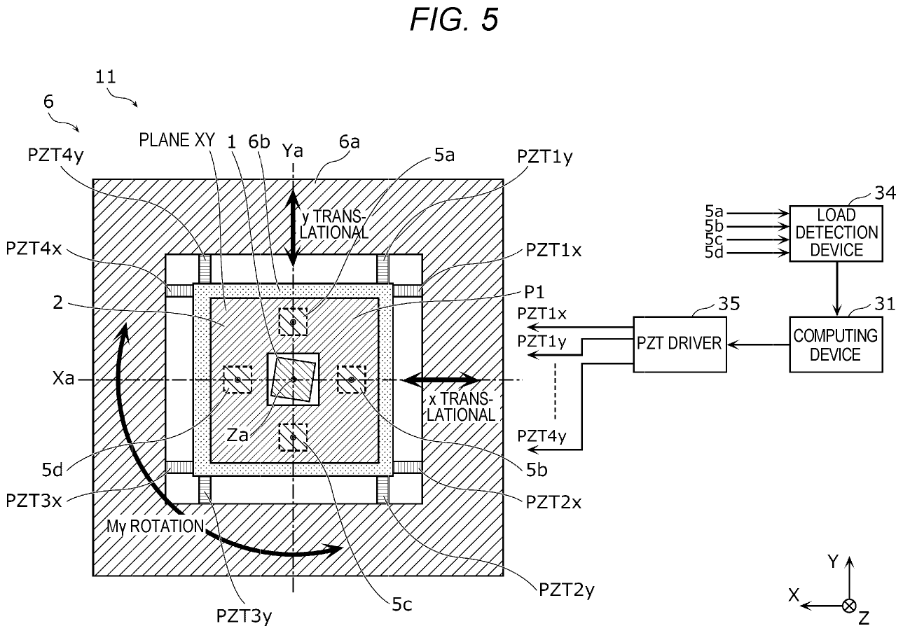

Next, the punching device 11 according to Embodiment 3 will be explained with reference to FIG. 5. The example in which relative misalignment between the punch 1 and the die 2 is calculated and the axis misalignment is adjusted by adjusting the assembly is shown in Embodiments 1 and 2, and an example in which misalignment is automatically adjusted will be explained in Embodiment 3.

FIG. 5 is a view showing a drive unit 6 of the punching device 11 according to Embodiment 3. In FIG. 5, not only a main structure of the drive unit 6 but also a structure of a control equipment group positioned in the outside of the drive unit 6 are shown.

As shown in FIG. 5, the measuring instruments 5a to 5d capable of detecting loads in three-axis directions are arranged above the drive unit 6. These measuring instruments 5a to 5d are arranged between the die 2 and the drive unit 6.

First, the drive unit 6 will be explained in detail. The drive unit 6 is formed by a frame part 6a, a movable part 6b, and a plurality of piezoelectric actuators. The movable part 6b is arranged under the measuring instrument 5a, capable of moving in the Xa-axis direction and the Ya-axis direction in the plane XY as well as capable of rotating about the Za-axis. The frame part 6a has a frame shape, which is arranged on an outer side of the movable part 6b and fixed to a later-described base plate 25. The plural piezoelectric actuators include eight piezoelectric actuators PZT1x, PZT1y, PZT2x, PZT2y, PZT3x, PZT3y, PZT4x, and PZT4y, which are arranged between the movable part 6b and the frame part 6a. When the plural piezoelectric actuators are driven, the movable part 6b, the measuring instruments 5a to 5d arranged above the movable part 6b and the die 2 can be moved and rotated.

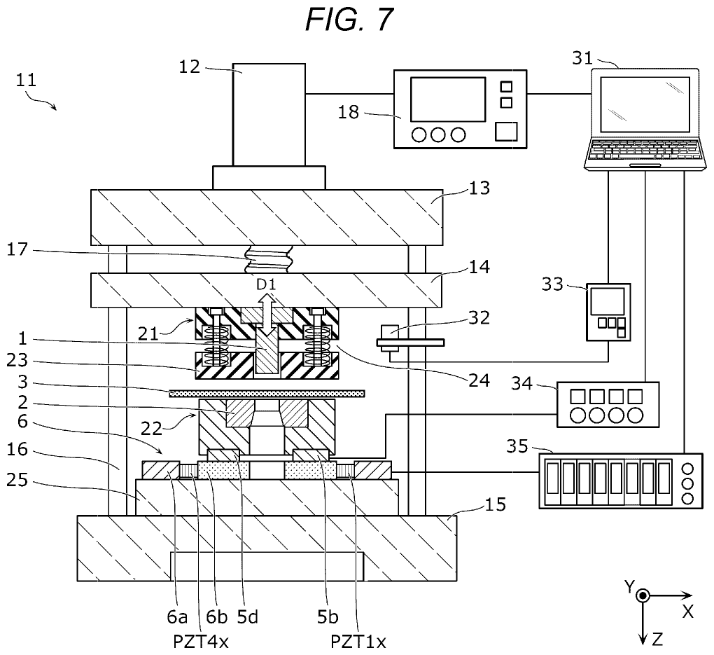

As described above, the die 2 as a lower die is arranged above the movable part 6b of the drive unit 6 in the punching die. The punch 1 is fixed to an upper die 21 (see FIG. 7), which can move along the Za-axis with the upper die at the time of punching and does not move in directions other than that direction. Generally, the clearance between the punch 1 and the die 2 in the die is approximately ten-odd micrometers, and slight rotation within the clearance is enough even in the rotation about the axis; therefore, the above structure is sufficient to function for solving the problems in the present application.

The eight piezoelectric actuators are respectively connected to a PZT driver 35 provided on the outside. Furthermore, the PZT driver 35 is connected to a computing device 31. The computing device 31 detects a processing resistance generated at the time of punching processing from the measuring instruments 5a to 5d, computing a relative eccentricity between the punch 1 and the die 2 from component forces in the plane XY. As a result of computing, when the punch 1 is eccentric with respect to the die 2, the respective piezoelectric actuators are driven by using the PZT driver 35.

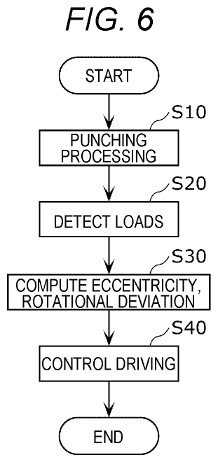

Here, a method of punching processing using the punching device will be explained with reference to FIG. 6.

FIG. 6 is a flowchart showing the method of punching processing using the punching device 11.

First, punching processing is performed (Step S10), and the loads x1 to x4, y1 to y4, and z1 to z4 at the time of punching are detected by using the measuring instruments 5a to 5d (Step S20).

Next, the translational forces x, y in the plane XY and the moment Mγ are calculated based on the detected loads x1 to x4, y1 to y4, and z1 to z4 by using the computing device 31 (Step S30). Presence of eccentricity and rotational deviation is checked by these values.

When the eccentricity occurs, the movable part 6b of the drive unit 6 is moved in parallel in the plane XY by controlling the eight piezoelectric actuators to drive (Step S40). A movement distance and a movement direction at the time of moving the movable part 6b, namely, the die 2 are calculated based on component forces of the translational forces x and y.

In the case where rotational deviation occurs, the movable part 6b of the drive unit 6 is rotated about the Za-axis to move by controlling the eight piezoelectric actuators to be driven (Step S40). A rotation angle and a rotation direction at the time of rotating the movable part 6b, namely, the die 2 are calculated based on the moment Mγ about the Za-axis.

Time necessary for a series of operations shown in Steps S10 to S40 is normally lower than 100 msec., therefore, it is preferable that this sequence is operated at every punching processing. In a case where a cycle of punching is faster than the series of sequence, it is possible to operate the drive unit 6 after performing cycles of punching several times. Moreover, in a case where the operation is not completed due to many measurement errors even after the series of operations, the drive unit 6 may be operated after performing statistical processes. The statistical processes can be performed by the computing device 31 for computing eccentricity and rotational deviation.

Here, the entire structure of the punching device 11 will be explained with reference to FIG. 7.

FIG. 7 is a view showing the entire structure of the punching device 11 according to Embodiment 3.

A servo-screw press device with good controllability is adopted as the punching device 11.

The punching device 11 rotates a ball screw 17 connected to a servo motor 12 based on an instruction from a controller 18 to drive a movable plate 14 vertically (in the Za-axis direction). The upper die 21 in which the punch 1 is built is installed to the movable plate 14 in a state where a stripper 23, compression springs 24 and so on for pressing the workpiece 3 at the time of punching are assembled, performing punching operation vertically along the Za-axis. On the other hand, a lower die 22 in which the die 2 is built is attached to the movable part 6b of the drive unit 6 through the measuring instruments 5a to 5d. The frame part 6a of the drive unit 6 is attached to the base plate 25 to be integrated with the punching device 11. The workpiece 3 is arranged between the upper die 21 and the lower die 22, which is configured to be carried in the Xa-axis direction or the Ya-axis direction so as to correspond to the punching operation of the punching device 11 by a not-shown drive mechanism.

On the outside of a body of the punching device 11, a load detection device (amplifier unit) 34 of the measuring instruments 5a to 5d, the PZT driver 35 for controlling the plural piezoelectric actuators PZT1x to PZT4y, a gap sensor 32 for detecting a position of the movable plate 14 at high accuracy and a gap sensor amplifier (control amplifier) 33 are arranged. The load detection device 34, the PZT driver 35, the gap sensor 32 and the gap sensor amplifier 33 are connected to a controller (personal computer) as the computing device 31. The computing device 31 is connected to the controller 18 of the punching device 11.

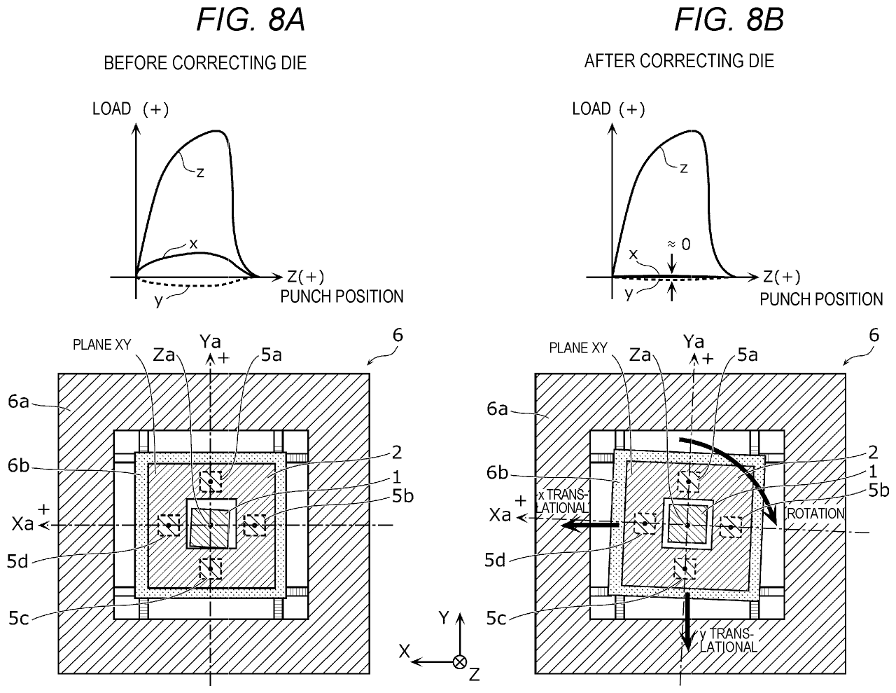

Furthermore, a detailed example of operations in the punching device 11 will be explained with reference to FIGS. 8A and 8B.

FIGS. 8A and 8B are views showing the loads x and y detected in the punching device 11 and correction of misalignment between the punch 1 and the die 2 according to Embodiment 3. In FIGS. 8A and 8B, not only the loads x and y but also the processing resistance force z generating in the Za-axis direction are shown.

First, the punching operation of the first time is performed based on an instruction from the controller 18 in a state where the punching die is assembled to the punching device 11.

As a result of the punching operation of the first time, supposing that, for example, loads x and y are generated respectively in the Xa-axis direction and the Ya-axis direction as shown on an upper part of FIG. 8A. The eccentricity occurs between the punch 1 and the die 2 as shown in a lower part of FIG. 8A. When a load generated in the plane XY is f1, the load f1 is represented by Formula (5).

f1=k·Δd (5)
(k: spring constant, Δd: eccentric amount)

Next, when the punching operation of the second time is performed, the die 2 is moved by an arbitrary moving distance by using the drive unit 6. Specifically, the drive unit 6 is moved by using a relation between voltages and a displacement amount of the piezoelectric actuators PXT1x to PZT4y. The movement distance is, for example, 2 micrometers in this case. As for the movement direction, it is preferable to move the die 2 in an opposite direction to the load vector on the plane XY generated at the time of punching operation of the first time. That is because the load vector on the plane XY is further reduced or a sign is inverted by moving the die 2 by two micrometers as in what state relative positions of the punch 1 and the die 2 are is not clear in the punching operation of the first time.

After the die 2 is moved with respect to the punch 1 by the drive unit 6, the workpiece 3 is carried horizontally and the punching operation of the second time is performed. When a load on the plane XY generated by the punching operation of the second time is f2, the load f2 is represented by Formula (6).

f2=k(Δd−2) (6)

Here, a spring constant k in this system can be calculated as shown in Formula (7) by calculating Formula (5)-Formula (6).

k=(f1−f2)/2 (7)

The eccentric amount Δd can be calculated by substituting the spring constant k calculated by Formula (7) and the load f1 into Formula (5). Therefore, when the punching operation of the third time is performed, the position of the die 2 is moved to a position where the eccentric amount of the punch 1 and the die 2 at the time of the punching operation of the first time becomes zero by using the drive unit 6. The die 2 is moved and rotated by using the drive unit 6 in this manner, thereby adjusting misalignment of axes and rotational deviation between the punch 1 and the die 2. Also according to the example, adjustment of axes in consideration of the spring constant k in the system of the punching device 11 can be performed.

In a case where the load generated on the plane XY after the punching operation of the third time is, for example, not zero, punching processing can be performed by automatically adjusting axes while sequentially executing the above operations each time. Also in a case where translational forces (loads x and y) on the plane XY are zero and only the moment My about the Za-axis occurs, the rotation angle can be adjusted in the same manner.

FIG. 8B shows a state in which the loads x, y on the plane XY and the moment My are zero, and the clearance between the punch 1 and the die 2 is uniform as a result of the above operations.

When the state in which the clearance is uniform can be formed easily, it is possible to prevent the punch 1 and the die 2 from colliding with each other and being broken or chipped due to the punching operation, or reduction in tool lifetime caused by occurrence of excessive loads due to the punching processing is not incurred. Accordingly, stable punching processing can be performed, and setting positions are the same as those before replacement even when tools are replaced, as a result, it is possible to expect that variations in lifetime of respective tools are reduced.

Although the die 2 is moved by 2 micrometers at the time of the second punching, the value is changed depending on the clearance between the punch 1 and the die 2; therefore, the value maybe suitably changed according to the die to be used. Moreover, the drive unit 6 is driven by using the piezoelectric actuators in the above example; however, the drive unit 6 may be driven by a motor and the like. The die 2 is moved or rotated for adjusting axis misalignment and rotational deviation in the embodiment; however, the punch 1 may be moved or rotated instead of the die 2.

### Other Embodiments

The punching device has been explained above based on the embodiments. The present disclosure is not limited to the above embodiments. For example, aspects obtained by achieving various modifications known to those skilled in the art with respect to the above embodiments and aspects realized by arbitrarily combining components and functions in the embodiments within a scope not departing from the gist of the present disclosure are also included in the present disclosure.

For example, three measuring instruments 5a to 5c in the measuring instruments 5a to 5d of the punching device 11 may be first processing resistance measuring instruments for calculating the translational forces x and y at the time of punching the workpiece 3 and one measuring instrument 5d may be a second processing resistance measuring instrument for calculating the moment My about the Za-axis extending along the punching direction D1. In this case, respective first processing resistance measuring instruments are arranged on the same plane XY orthogonal to the Za-axis extending along the punching direction D1. One or more first processing resistance measuring instruments may be respectively arranged in three areas in the four areas divided by the orthogonal two axes (Xa-axis and Ya-axis) on the plane XY when the plane XY is seen from the punching direction Dl. Moreover, the computing device 31 may calculate the movement direction of the punch 1 or the die 2 based on the translational forces x and y calculated by the first processing resistance measuring instruments as well as may calculate the rotation angle about the axis of the punch 1 or the die 2 based on the moment Mγ about the axis calculated by the second processing resistance measuring instrument.

The punching device according to the present disclosure can realize a punching device for realizing elongation of the lifetime of the die and high-quality punching processing. As it is possible to change a tool clearance suitably, the device can be also used for a cutting tool. For example, in a case where an extremely thin film with a thickness of several micrometers is cut, extremely high-accuracy clearance adjustment will be necessary, and the present disclosure can be applied to a cutting device or the like. That is, the present disclosure can be applied to a shearing device that shears a flat workpiece by a shearing tool. In that case, the shearing device may include the measuring instrument 5 for calculating translational forces generated in respective directions of orthogonal two axes (Xa-axis and Ya-axis) in the plane XY orthogonal to the Za-axis extending along a direction in which a shearing force works in forces generated at the time of shearing the workpiece 3 in the same manner as the punching device 11.

The computing device 31 can include a processor executing instructions stored in an associated memory to perform steps such as those in FIG. 6.

The punching device and the like according to the present disclosure can be widely applied as devices punching workpieces such as metal, plastic and composite materials.

What is claimed is:

1. A punching device punching a flat workpiece by a punch, comprising:
a measuring instrument configured to calculate translational forces generated in respective directions of orthogonal two axes in a plane orthogonal to an axis extending along a punching direction by the punch in forces generated at the time of punching the workpiece.

2. The punching device according to claim 1,
wherein the measuring instrument is further configured to calculate a moment about the axis extending along the punching direction.

3. The punching device according to claim 2,
wherein at least three measuring instruments are included, and
the respective measuring instruments are arranged on the same plane orthogonal to the axis extending along the punching direction.

4. The punching device according to claim 3,
wherein one or more measuring instruments are respectively arranged at three areas within four areas divided by the orthogonal two axes on the plane when the plane is seen from the punching direction.

5. The punching device according to claim 2, further comprising:
a die having a shape corresponding to the punch; and
a computing device calculating movement distances of the die or the punch to respective directions of the orthogonal two axes,
wherein the computing device calculates the movement distances based on the translational forces.

6. The punching device according to claim 5,
wherein the computing device further calculates a rotation angle about the axis of the die or the punch based on the moment about the axis.

7. The punching device according to claim 1,
wherein the measuring instruments are first processing resistance measuring instruments for calculating translational forces generated at the time of punching the workpiece, and
further comprising a second processing resistance measuring instrument configured to calculate a moment about the axis extending along the punching direction.

8. The punching device according to claim 7,
wherein at least three first processing resistance measuring instruments are provided, and
the respective first processing resistance measuring instruments are arranged on the same plane orthogonal to the axis extending along the punching direction.

9. The punching device according to claim 8,
wherein one or more first processing resistance measuring instruments are respectively arranged at three areas within four areas divided by the orthogonal two axes on the plane when the plane is seen from the punching direction.

10. The punching device according to claim 7, further comprising:
a die having a shape corresponding to the punch; and
a computing device calculating movement distances of the die or the punch to respective directions of the orthogonal two axes,
wherein the computing device calculates the movement distances based on the translational forces calculated by the first processing resistance measuring instruments.

11. The punching device according to claim 10,
wherein the computing device further calculates a rotation angle about the axis of the die or the punch based on the moment about the axis calculated by the second processing resistance measuring instrument.

12. A shearing device shearing a flat workpiece by a shearing tool, comprising:
a measuring instrument configured to calculate translational forces generated in respective directions of orthogonal two axes in a plane orthogonal to an axis extending along a direction in which a shearing force works in forces generated at the time of shearing the workpiece.

13. The punching device according to claim 1, wherein the measuring instrument is a piezoelectric load sensor.
